(19) United States
(12) Patent Application Publication
(10) Pub. No.: US 2024/0049729 A1
(43) Pub. Date: Feb. 15, 2024

(54) DISPLACING APPARATUS AND METHOD FOR CREATING BAKED GOODS WITH A PREFORMED CAVITY THEREIN

(71) Applicant: Jamie Julene Skinner, Iowa City, IA (US)

(72) Inventor: Jamie Julene Skinner, Iowa City, IA (US)

(21) Appl. No.: 18/232,481

(22) Filed: Aug. 10, 2023

Related U.S. Application Data
(60) Provisional application No. 63/396,639, filed on Aug. 10, 2022.

(51) Int. Cl. A21B 3/13

(52) U.S. Cl. CPC A21B 3/135; A21B 3/132

(57) ABSTRACT

An apparatus and method for creating a baked cupcake with a preformed void therein for receiving filling, where the apparatus includes a plurality of tapered food grade silicone cavity creating constructions which are ganged together and are disposed partially in unbaked batter which rises to form a surface against the cavity creating construction, which creates a preformed void for later insertion of filling after the cupcake has been baked and the cavity creating constructions removed.

### CROSS REFERENCE TO RELATED APPLICATIONS

This application claims the benefit of a provisional application filed on Aug. 10, 2022, and having Ser. No. 63/396,639, by the same inventor and entitled “HOLLOWER BAKING DISPLACER” which is hereby incorporated herein in its entirety by this reference.

### FIELD OF THE INVENTION

The present invention generally relates to baking and tools for creating baked goods with cavities therein for post baking insertion of fillings.

### BACKGROUND OF THE INVENTION

While the following discussion is focused on cupcakes, it should be understood that cupcakes are merely a single example of many different types of baked goods that could be made with the present invention. In the past, various methods and tools have been used to create baked goods with space therein for insertion of fillings into such baked goods. One of such tools is the CupCake corer, described at https://www.westmark.de/en-us/cupcake-cover-30132270.com. This device uses manual pressure to insert the corer into the top of a baked cupcake and remove a portion of the cupcake therefrom as the corer is removed from the cupcake. Another method is to use a cupcake pan with a protuberance extending upward from the bottom of each individual cupcake batter receiving region. This device results in causing the batter as it is introduced into the cupcake pan to have a void therein extending from the bottom upward into the finished cupcake. Still others have inserted filling, for example a piece of chocolate, into the cupcake batter before the cupcake is baked.

While these methods have enjoyed some success and have been used in the past, each has limitations and drawbacks. For example, the corer, while it does create a cavity at the top of the cupcake, results in the removal of and non-use of significant portions of the baked cupcake resulting in increased labor and waste of batter.

Use of a cupcake pan with a protuberance at the bottom can have several downsides, such as making it difficult to use standard cupcake liners and making it more difficult to remove cupcakes intact from the pan.

The method of inserting some type of filling before baking can create problems of exposing the filling to elevated temperatures during baking which may eliminate the types of fillings that are best if not baked.

Still other methods have been done but none are believed to provide all of the benefits of the present invention.

Consequently, there exists a need for improved methods and apparatuses for creating a baked cupcake with a void therein for insertion of filling.

### SUMMARY OF THE INVENTION

It is an object of one aspect of the present invention to provide an apparatus for reducing the effort expended and labor required to create a baked cupcake with a void therein for receiving a filling.

It is a feature of one aspect of the present invention to include a plurality of cavity creating construction coupled together.

It is an advantage of the present invention to reduce the time and labor in making a cupcake with a cavity therein located at the top of the cupcake.

It is an additional feature of the present invention to provide a lightweight and compact device.

It is an additional advantage of this embodiment of the present invention to provide for ease of use and cleaning.

Accordingly, the present invention is:
A system for baking a plurality of edible items, the system comprising:
   a pan with a rectangular array of a plurality of cavities therein each for receiving therein edible matter to be baked;
   a rectangular array of a plurality of cavity creating constructions configured to be partially disposed in said plurality of cavities;
   a stainless steel spine coupled to each of said plurality of cavity creating constructions so that a movement of said stainless steel spine in a first direction will result in a movement of each of said plurality of cavity creating constructions in a direction parallel to said first direction; and
   said plurality of cavity creating constructions each is made of a heat-resistant food grade silicone, and each further having a conical shape where a distal portion from said stainless steel spine has a smaller cross-sectional area than a more proximal portion.

Additionally the present invention is a method of making a plurality of baked cupcakes with preformed voids therein, the method comprising the steps of:
providing a pan having a rectangular array of a plurality of cavities therein configured for receiving therein unbaked batters;
providing unbaked batter into each of said plurality of cavities;
providing a stainless steel spine with a rectangular array of a plurality of tapered cavity creating constructions coupled thereto;
inserting each of said plurality of tapered cavity creating constructions into a different one of said plurality of cavities and into unbaked batter disposed in said plurality of cavities;
allowing said unbaked batter to remain outside of an oven while said unbaked batter rises;
inserting said pan, said unbaked batter, said stainless steel spine, and said plurality of tapered cavity creating constructions into an oven;
baking said unbaked batter, to make a plurality of baked goods;
simultaneously removing said each of said plurality of said tapered cavity creating constructions from said pan by moving said stainless steel spine in a first direction, so that a first distal portion of a first cavity creating construction of said plurality of tapered cavity creating constructions moves into a space which was immediately earlier occupied by a more proximal portion of said first cavity creating construction, so that a preformed cavity is exposed in each of said plurality of baked goods; and
filling said preformed cavity with an edible filling material.

### BRIEF DESCRIPTION OF THE DRAWINGS

FIG. 1 is a perspective view of a first embodiment of the present invention with a single 12 cupcake void creating apparatus.

FIG. 2 is a perspective view of a second embodiment of the present invention with a pair of 6 cupcake void creating apparatuses, disposed in a 12 cupcake pan of the prior art.

FIG. 3 is a perspective view of a portion of a bifurcatable mold used for creation of the cavity creating constructions 120 of the embodiment of FIG. 1.

FIG. 4 is an alternate embodiment of a portion of the apparatus of FIG. 2.

### DETAILED DESCRIPTION

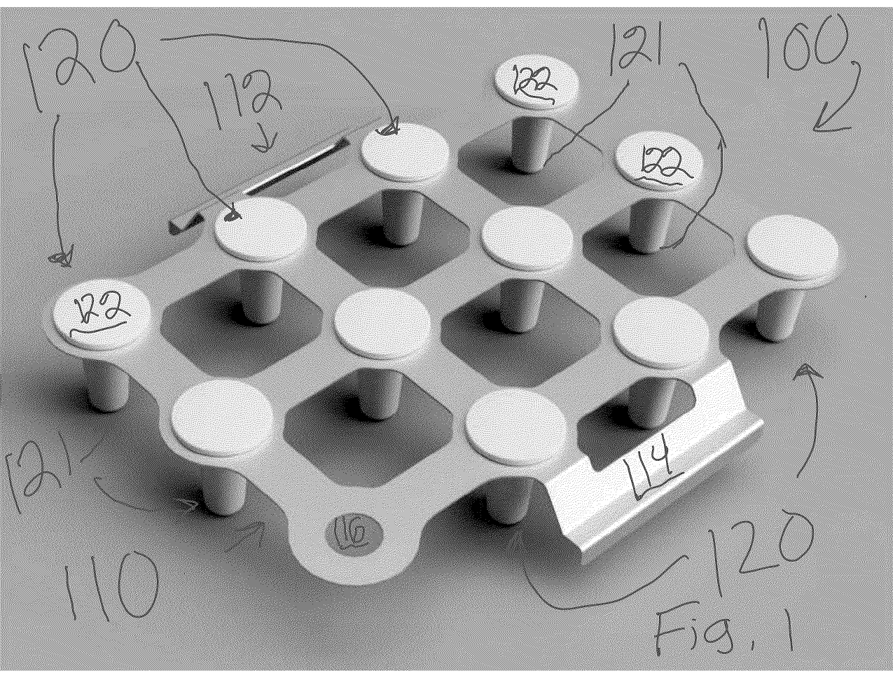

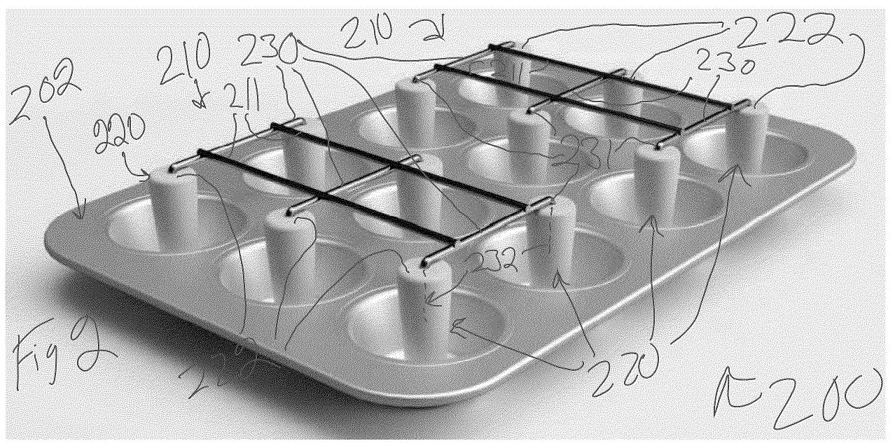

Now referring to the drawings wherein like numerals refer to like matter throughout and more particularly referring to FIG. 1, there is shown a perspective view of a first embodiment of the present invention with a displacing apparatus 100, having a rectangular array of cavity creating constructions 120 disposed in a rectangular array of holes 116 in connecting spine structure 110, where a diameter of a top portion 122 of each cavity creating construction 120 is larger than the diameter of each of said rectangular array of holes 116 and a diameter of said bottom portion 121 of each of said cavity creating constructions 120 is smaller than said diameter of said holes 116. Also shown attached to the connecting spine structure 110 is a pair of engagement members 112 and 114 which can be used to secure the apparatus 100 to a rectangular 12 cavity cupcake pan 202 in FIG. 2, and can be used as handles for the displacing apparatus 100.

Now referring to FIG. 2, there is shown a second embodiment of the present invention which includes a pair of baking displacers 210 each with a pair of stainless steel parallel spine rods 211 which orthogonally span and connect three spine traversing rods 230 with downward stainless steel bent legs (not shown, except for their top portions 231), which extend into longitudinal holes running from the top end 222 of each of the tapered cavity creating constructions 220. The locations of the representative bent legs are shown by dashed lines 230. The bent legs may be friction fit in the holes of the tapered cavity creating constructions 220, as opposed to the tapered cavity creating constructions 120 in FIG. 1 where the top sides 122 prevent the cavity creating constructions 120 from staying stuck to a portion of the pan 202 and being separated from the spine. The baking displacers 210 are shown as being engagement member-less in the sense that the handles and clamp like structures on the sides are not present. However, it should be understood that similar handles or clamping mechanisms could be used with the embodiment of FIG. 2, if desired.

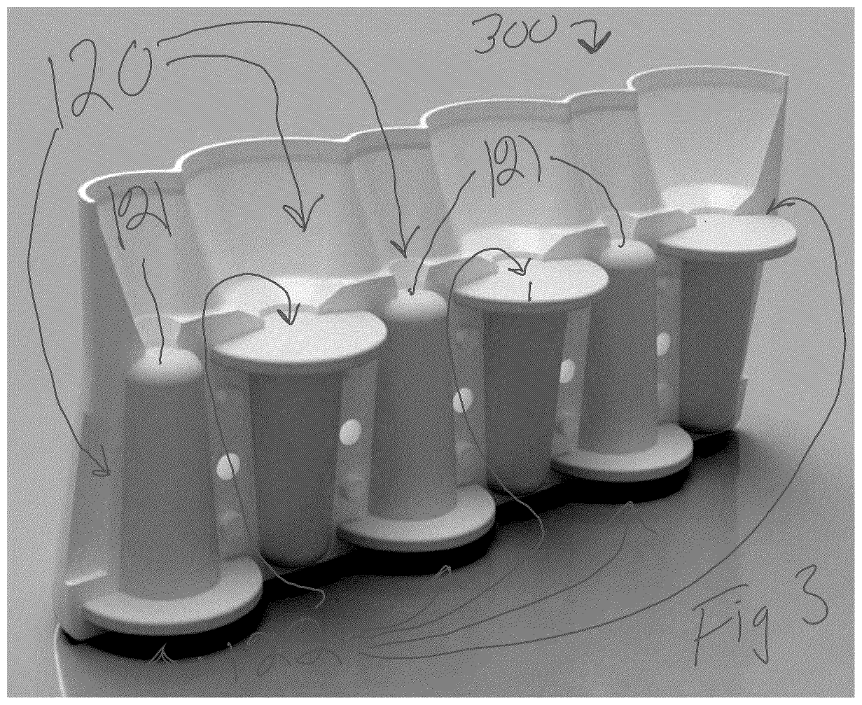

Now referring to FIG. 3, there is shown an image of portion 300 of a bifurcatable mold system for creating a plurality of cavity creating constructions 120 having been molded and now visible after an opposing portion (not shown) of the bifurcatable mold system has been removed.

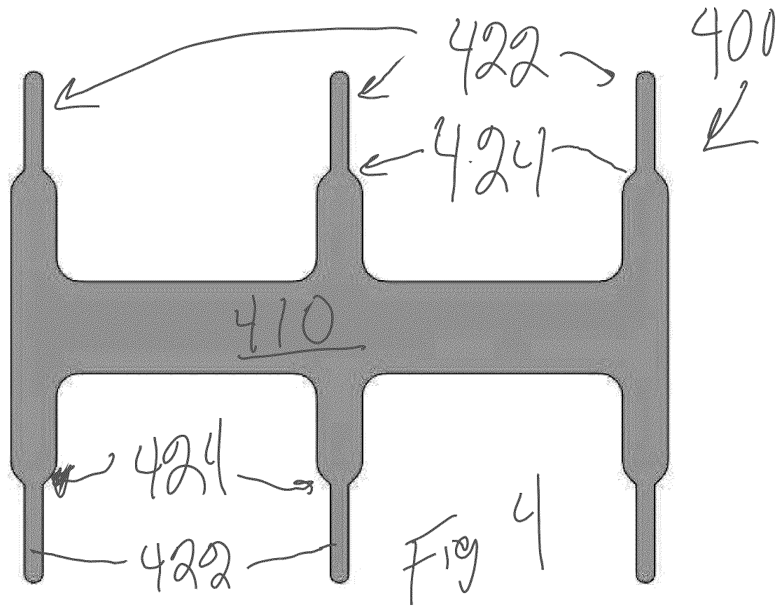

Now referring to FIG. 4, there is shown an alternate design for the pair of parallel spine rods 211 shown in FIG. 2, In FIG. 4 there is shown a single planar piece of stainless steel or other suitable food grade material which is configured with a single strong spine 410 with 6 legs 422 (before being bent downward into the page) at point 424. This system may be more sturdy, cheaper to manufacture, and easier to clean than the design of FIG. 2.

It is thought that the method and apparatus of the present invention will be understood from the foregoing description and that it will be apparent that various changes may be made in the form, construct steps and arrangement of the parts and steps thereof without departing from the spirit and scope of the invention or sacrificing all of their material advantages. The form herein described is merely a preferred exemplary embodiment thereof.

I claim:

1. A system for baking a plurality of edible items, the system comprising:
a pan with a rectangular array of a plurality of cavities therein each for receiving therein edible matter to be baked;
a rectangular array of a plurality of cavity creating constructions configured to be partially disposed in said plurality of cavities;
a stainless steel spine coupled to each of said plurality of cavity creating constructions so that a movement of said stainless steel spine in a first direction will result in a movement of each of said plurality of cavity creating constructions in a direction parallel to said first direction; and
said plurality of cavity creating constructions each is made of a heat-resistant food grade silicone, and each further having a conical shape where a distal portion from said stainless steel spine has a smaller cross-sectional area than a more proximal portion.

2. The system of claim 1 wherein said plurality of cavity creating constructions is disposed in a circular opening in said spine.

3. The system of claim 1 wherein said plurality of cavity creating constructions includes twelve cavity creating constructions.

4. The system of claim 1 wherein each of said plurality of cavity creating constructions has a portion where some material has been removed along a longitudinal line therein extending from a proximal portion to a more distal portion and said stainless steel spine has a plurality of legs coupled thereto each being sized, configured and operable to friction fit along said longitudinal line in said plurality of cavity creating constructions.

5. The system of claim 4 wherein said plurality of cavity creating constructions includes no more than six cavity creating constructions.

6. The system of claim 5 wherein said system includes a plurality of stainless steel spines.

7. A method of making a plurality of baked cupcakes with preformed voids therein, the method comprising the steps of:
providing a pan having a rectangular array of a plurality of cavities therein configured for receiving therein unbaked batters;
providing unbaked batter into each of said plurality of cavities;
providing a stainless steel spine with a rectangular array of a plurality of tapered cavity creating constructions coupled thereto;
inserting each of said plurality of tapered cavity creating constructions into a different one of said plurality of cavities and into unbaked batter disposed in said plurality of cavities;
allowing said unbaked batter to remain outside of an oven while said unbaked batter rises;
inserting said pan, said unbaked batter, said stainless steel spine, and said plurality of tapered cavity creating constructions into an oven;
baking said unbaked batter, to make a plurality of baked goods;
simultaneously removing said each of said plurality of said tapered cavity creating constructions from said pan by moving said stainless steel spine in a first direction, so that a first distal portion of a first cavity creating construction of said plurality of tapered cavity creating constructions moves into a space which was immediately earlier occupied by a more proximal portion of said first cavity creating construction, so that a preformed cavity is exposed in each of said plurality of baked goods; and
filling said preformed cavity with an edible filling material.

8. The method of claim 7 wherein said baked goods are cupcakes.

9. The method of claim 7 wherein said step of simultaneously removing each of said tapered cavity creating constructions includes moving at least twelve tapered cavity creating constructions.

10. The method of claim 7 wherein said step of simultaneously removing each of said tapered cavity creating constructions includes moving six tapered cavity creating constructions.

11. A system for baking a cupcake with a preformed surface for containing filling to be introduced after baking, the system comprising:
a spine portion which connects two sets of three substantially parallel stainless steel leg members;
said substantially parallel stainless steel leg members each being sized, configured and operable to friction fit with a tapered silicone cavity creating construction, so that when said spine portion is lifted after baking voids defined by each of said tapered silicon cavity creating constructions are exposed and are available to receive filling introduced therein.
